(19) United States
(12) Patent Application Publication
(10) Pub. No.: US 2019/0379826 A1
(43) Pub. Date: Dec. 12, 2019

(54) IMAGE CAPTURING APPARATUS AND METHOD OF CONTROLLING THE SAME

(71) Applicant: CANON KABUSHIKI KAISHA, Tokyo (JP)

(72) Inventor: Hiroyuki Furumochi, Musashimurayama-shi (JP)

(21) Appl. No.: 16/429,566

(22) Filed: Jun. 3, 2019

(30) Foreign Application Priority Data
Jun. 11, 2018 (JP) 2018-111243
Apr. 18, 2019 (JP) 2019-079568

(51) Int. Cl. H04N 5/232; H04N 5/378

(52) U.S. Cl. CPC H04N 5/23229; H04N 5/378; H04N 5/23296

(57) ABSTRACT

An image capturing apparatus comprises an image sensor including a plurality of pixels that photoelectrically convert a subject image, and a compression circuit that compresses signals from the plurality of pixels; a readout unit that reads out the signals of the plurality of pixels from the image sensor; and a control unit that, in accordance with an image capturing condition, controls a compression operation performed on the signals of the plurality of pixels by the compression circuit.

### BACKGROUND OF THE INVENTION

### Field of the Invention

The present invention relates to an image capturing apparatus and a control method thereof.

### Description of the Related Art

Recently, pixels in image sensors are being provided at finer levels, which increases the number of pixels and makes it possible to capture images at high resolutions. Even consumer image capturing apparatuses commonly have 10 million to 50 million pixels.

However, transfer paths from image sensors to image signal processing circuits have a set transfer capacity. This means that as the number of pixels in the image sensor increases, so too does the time required for transferring all of the image signals for a subject. Differences in the times at which upper and lower parts of the subject are transferred produces distortion. This is known as “rolling shutter distortion”.

In response to this issue, Japanese Patent Laid-Open No. 2010-252396 discloses reducing the amount of data to be transferred by compressing image signals within the image sensor.

According to the technique disclosed in Japanese Patent Laid-Open No. 2010-252396, compressing the image signals makes it possible to shorten the transfer time, which in turn makes it possible to suppress rolling shutter distortion. However, there is a problem in that if the image signals are compressed, the bit precision drops. This causes the image signals to degrade, which reduces the image quality.

### SUMMARY OF THE INVENTION

Having been achieved in light of the above-described issue, the present invention provides an image capturing apparatus that shortens transfer times while suppressing a drop in image quality.

According to a first aspect of the present invention, there is provided an image capturing apparatus comprising: an image sensor including a plurality of pixels that photoelectrically convert a subject image, and a compression circuit that compresses signals from the plurality of pixels; and at least one processor or circuit configured to function as the following units: a readout unit that reads out the signals of the plurality of pixels from the image sensor; and a control unit that, in accordance with an image capturing condition, controls a compression operation performed on the signals of the plurality of pixels by the compression circuit.

According to a second aspect of the present invention, there is provided a method of controlling an image capturing apparatus, the apparatus including an image sensor having a plurality of pixels that photoelectrically convert a subject image and a compression circuit that compresses signals of the plurality of pixels, and the method comprising: reading out the signals of the plurality of pixels from the image sensor; and in accordance with an image capturing condition, controlling a compression operation performed on the signals of the plurality of pixels by the compression circuit.

Further features of the present invention will become apparent from the following description of exemplary embodiments with reference to the attached drawings.

### BRIEF DESCRIPTION OF THE DRAWINGS

FIGS. 1A and 1B are diagrams illustrating the configuration of an image sensor according to an embodiment of the present invention.

FIGS. 2A and 2B are diagrams illustrating an example of the configuration of a pixel and a column ADC block according to an embodiment of the present invention.

FIG. 3 is a diagram illustrating a pixel arrangement in the image sensor according to an embodiment of the present invention.

FIG. 4 is a block diagram illustrating the configuration of an image capturing apparatus according to an embodiment of the present invention.

FIG. 5 is a diagram illustrating a connection between the image sensor and an image capturing signal processing circuit.

FIG. 6 is a diagram illustrating conditions for determining whether or not to carry out compression in the image sensor.

FIG. 7 is a diagram illustrating control timing for the image sensor.

FIG. 8 is a flowchart illustrating operations for determining whether or not to carry out compression in the image sensor.

### DESCRIPTION OF THE EMBODIMENTS

Hereinafter, an embodiment of the present invention will be described in detail with reference to the appended drawings.

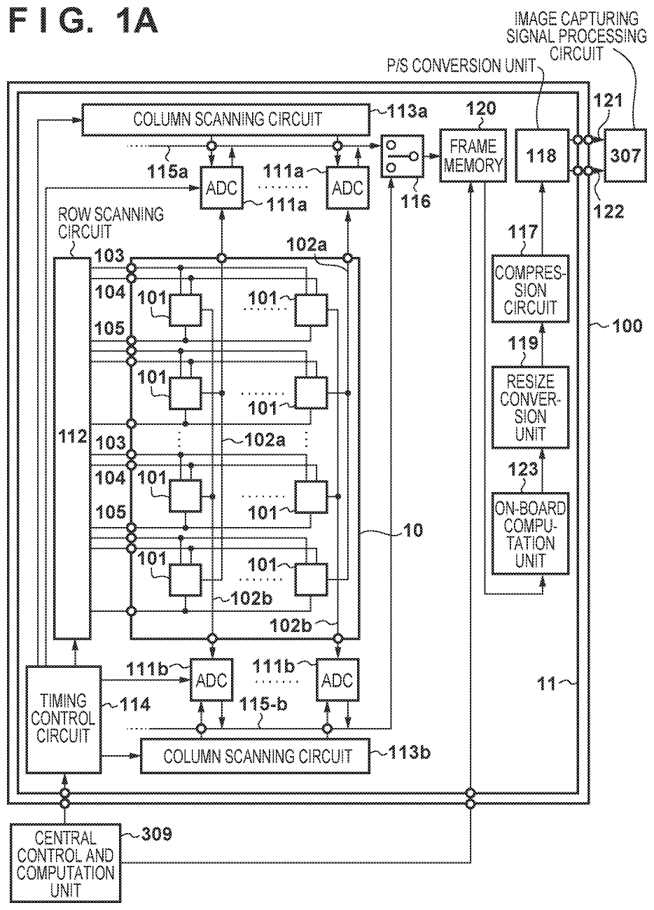

FIG. 1A is a block diagram illustrating the configuration of an image sensor 100 according to an embodiment of the present invention, and FIG. 1B is a schematic diagram illustrating the external appearance of the image sensor 100. As illustrated in FIG. 1B, the image sensor 100 is constituted by a first semiconductor chip 10 (image capturing layer) and a second semiconductor chip 11 (circuit layer), and the second semiconductor chip 11 is layered upon the first semiconductor chip 10.

A pixel unit constituted by a plurality of pixels 101 arranged in a matrix is provided in the first semiconductor chip 10, on a light-incident side, i.e., a side where the light of an optical image is received, of the chip. The pixels 101 arranged on the first semiconductor chip 10 in a matrix are connected to transfer signal lines 103, reset signal lines 104, and row selection signal lines 105, in units of rows in the horizontal direction (a row direction). On the other hand, the pixels 101 are connected to a column output line 102a or 102b in the vertical direction (a column direction). The pixels 101 connected to the column output line 102a are a first pixel group, and the pixels 101 connected to the column output line 102b are a second pixel group.

Column ADC (analog-to-digital converter) blocks 111a and 111b provided for the respective columns, and pixel driving circuits such as a row scanning circuit 112, column scanning circuits 113a and 113b, and a timing control circuit 114, are formed on the second semiconductor chip 11. Furthermore, a changing switch 116, frame memory 120, an on-board computation unit 123, a resize conversion unit 119, a compression circuit 117, and a parallel/serial conversion unit (“P/S conversion unit” hereinafter) 118 are also provided.

By forming the pixels 101 on the first semiconductor chip 10, and the pixel driving circuits, memory circuits, computation circuits, and the like on the second semiconductor chip 11 in this manner, the image capturing layer and the circuit layer of the image sensor 100 can be manufactured through separate processes. As a result, the wiring in the circuit layer can be made finer and denser, and the device itself can therefore be made faster, smaller, and capable of higher performance.

Charge accumulation in and readout from the pixels 101 of the image sensor 100 are controlled by control signals from the row scanning circuit 112, through the transfer signal lines 103, the reset signal lines 104, and the row selection signal lines 105. Signals are read out from the pixels 101 in the row selected by the row scanning circuit 112. In the present embodiment, two output channel systems are provided as output channels. The first output channel is constituted by the column ADC block 111a, the column scanning circuit 113a, and a signal line 115a, and the second output channel is constituted by the column ADC block 111b, the column scanning circuit 113b, and a signal line 115b. Signals can be read out from two rows' worth of pixels 101 in parallel as a result.

The signals read out from the pixels 101 in the first pixel group are sent to the column ADC block 111a in the first output channel via the column output line 102a in each column, and are AD-converted. Likewise, the signals read out from the pixels 101 in the second pixel group are sent to the column ADC block 111b in the second output channel via the column output line 102b in each column, and are AD-converted. Columns for readout are then selected in sequence by the column scanning circuit 113a or 113b, and the AD-converted image signals are output to the changing switch 116 via the signal line 115a or 115b. It is also possible to read out signals from the pixels 101 one row at a time, using only one of the first and second output channels.

The timing control circuit 114 sends timing signals to the row scanning circuit 112, the column ADC blocks 111a and 111b, and the column scanning circuits 113a and 113b under the control of a central control and computation unit 309.

The changing switch 116 is a switch for selectively outputting, in sequence to the frame memory 120, the image signals output from the signal lines 115a and 115b. The frame memory 120 temporarily stores the output image signals as image data.

The on-board computation unit 123 carries out computations for resizing processing, compression processing, and the like on image data in accordance with a driving mode. The resize conversion unit 119 resizes the image data saved in the frame memory 120 to the necessary angle of view on the basis of the result of the calculation performed by the on-board computation unit 123, and outputs the resized image data to the compression circuit 117.

The compression circuit 117 carries out a compression operation on the image signal using a compression method such as a wavelet transform method or the like. When compression is carried out, the bit precision drops, and the image quality will drop as a result. However, unnecessary components such as noise are also removed, and noise is therefore reduced as well.

Note that when the resizing and compression processing are not necessary, the signal is transferred from the changing switch 116 directly to the P/S conversion unit 118. The P/S conversion unit 118 carries out parallel/serial conversion on the image data and transfers that image data to an image capturing signal processing circuit 307 outside the image sensor 100.

The image sensor 100 and the image capturing signal processing circuit 307 are connected by a plurality of lanes, and depending on the driving mode, signals from different pixels or signals from the same pixel are output having been divided between a main stream 121 and a sub stream 122, or are output from the main stream 121 only. This multi-stream driving, in which two systems of image signals are output from the image sensor 100 in parallel, makes it possible to output the image signals from the image sensor 100 at high speeds.

Driving that reads out all pixels, readout driving that thins the number of pixels by ⅓, ⅕, or the like in the vertical direction, readout driving that mixes pixel signals in the horizontal direction, driving that combines vertical thinning and horizontal mixing, or the like can be selected as the readout driving method of the image sensor 100. It is also possible to select multi-stream driving 1, in which driving for reading out all the pixels and driving that combines ⅓ vertical thinning with horizontal mixing driving are carried out simultaneously, multi-stream driving 2, in which driving that combines ⅓ vertical thinning with horizontal mixing driving and driving that combines 1/7 vertical thinning with horizontal mixing driving are carried out simultaneously, or the like. In the present embodiment, driving that reads out all of the pixels is employed when shooting a still image, and driving that performs ⅕ thinned readout is employed before shooting a still image, for example.

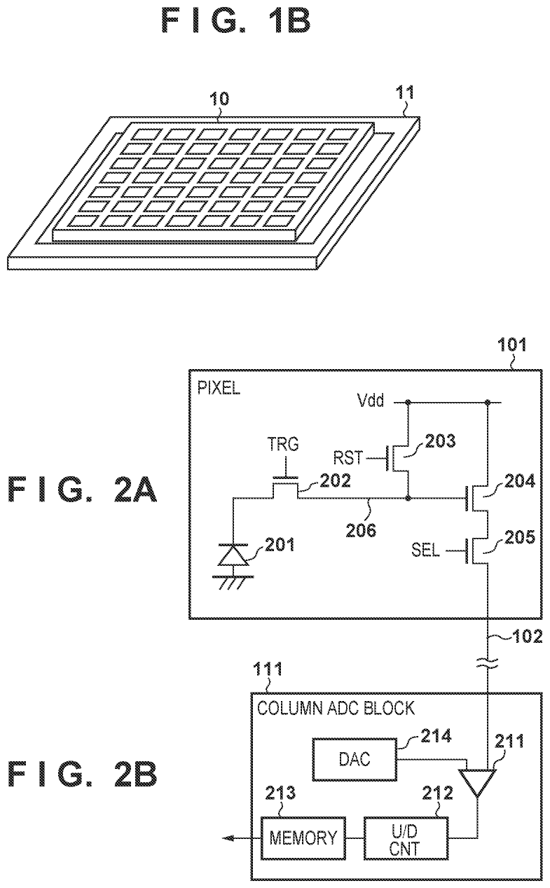

FIGS. 2A and 2B are diagrams illustrating the configuration of a single pixel 101 and a single column ADC block 111 in the image sensor 100 according to the present embodiment in detail. An overview of the operations of the image sensor 100 according to an embodiment of the present invention will be given using FIGS. 1A, 1B, 2A and 2B. Because the column ADC block 111a and the column ADC block 111b have the same configuration, the blocks are indicated as “column ADC block 111” in FIG. 2B.

In FIG. 2A, a photodiode (PD) 201 included in the pixel 101 photoelectrically converts received light into a photocharge (electrons, here) having a charge amount based on the amount of the received light. A transfer transistor 202 is connected between the cathode of the PD 201 and the gate of an amplifying transistor 204, and turns on in response to a transfer pulse φTRS being applied to the gate of the transfer transistor 202 via the transfer signal lines 103. A node electrically connected to the gate of the amplifying transistor 204 constitutes a floating diffusion (FD) unit 206. When the transfer transistor 202 turns on in response to the transfer pulse φTRS, the photocharge obtained by the photoelectric conversion in the PD 201 is transferred to the FD unit 206.

A reset transistor 203 has its drain connected to a pixel power source Vdd and its source connected to the FD unit 206, and turns on in response to a reset pulse φRST being applied to the gate of the reset transistor 203 via the reset signal lines 104. When the reset transistor 203 turns on before the photocharge is transferred from the PD 201 to the FD unit 206, the charge at the FD unit 206 is reset to the pixel power source Vdd.

The amplifying transistor 204 has its gate connected to the FD unit 206 and its drain connected to the pixel power source Vdd. A select transistor 205 has its drain connected to the source of the amplifying transistor 204 and its source connected to a column output line 102, and turns on in response to a select pulse φSEL being applied to the gate of the select transistor 205 via the row selection signal lines 105.

While the select transistor 205 is on, first, the potential at the FD unit 206 following the reset by the reset transistor 203 is output to the column output line 102 as a reset level. Furthermore, when the transfer transistor 202 is turned on, the potential at the FD unit 206 following the photocharge transfer is output to the column output line 102 as a signal level. N-channel MOS transistors are used as the transistors 202 to 205 in the present embodiment.

Note that the configuration of the pixel 101 is not limited to that described above, and for example, a circuit configuration in which the select transistor 205 is connected between the pixel power source Vdd and the drain of the amplifying transistor 204 can be used as well. Furthermore, the configuration is not limited to the above-described four-transistor configuration, and may instead be a three-transistor configuration in which a single transistor functions as the amplifying transistor 204 and the select transistor 205, for example.

The signal output from the pixel 101 via the column output line 102 is sent to the column ADC block 111. The column ADC block 111 includes a comparator 211, an up-down counter (U/D CNT) 212, memory 213, and a DA (digital-to-analog) converter (DAC) 214.

One of a pair of input terminals of the comparator 211 is connected to the column output line 102, and the other is connected to the DAC 214. The DAC 214 outputs a ramp signal, in which the signal level changes in ramp shape with the passage of time, on the basis of a reference signal input from the timing control circuit 114. The comparator 211 then compares the level of the ramp signal input from the DAC 214 with the level of the signal input from the column output line 102. The timing control circuit 114 outputs the reference signal to the DAC 214 on the basis of a command from the central control and computation unit 309.

The comparator 211 outputs a high-level comparison signal when the image signal level is lower than the ramp signal level, and outputs a low-level comparison signal when the image signal level is higher than the ramp signal level, for example. The up-down counter 212 is connected to the comparator 211, and counts periods when the comparison signal is high-level or periods when the comparison signal is low-level, for example.

The signals output from the pixels 101 are converted into digital values as a result of this counting process. Note that an AND circuit may be provided between the comparator 211 and the up-down counter 212, a pulse signal may be input to the AND circuit, and the number of pulses may be counted by the up-down counter 212.

The memory 213 is connected to the up-down counter 212, and stores the count value counted by the up-down counter 212. In the column ADC block 111, a count value corresponding to the signal level after a predetermined image capturing time has passed may be counted after a count value corresponding to the reset level of the pixels 101 is counted, and the difference may be stored in the memory 213. Then, the count value stored in the memory 213 is transferred, as an image signal, to the changing switch 116 via the signal line 115a or the signal line 115b in synchronization with a signal from the column scanning circuit 113.

It goes without saying that the column ADC block 111 is not limited to the above-described configuration, and a known column ADC may be used.

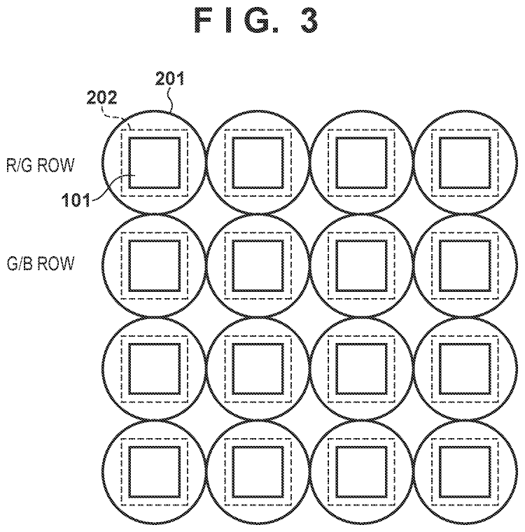

FIG. 3 is a diagram schematically illustrating a pixel arrangement in the image sensor 100 according to the present embodiment. A Bayer pattern is applied to color filters, with the pixels in odd-numbered rows being provided with red (R) and green (Gr) color filters in an alternating manner in order from the left. The pixels in even-numbered rows are provided with green (Gb) and blue (B) color filters in an alternating manner in order from the left. On-chip microlenses 201 are formed on the color filters 202.

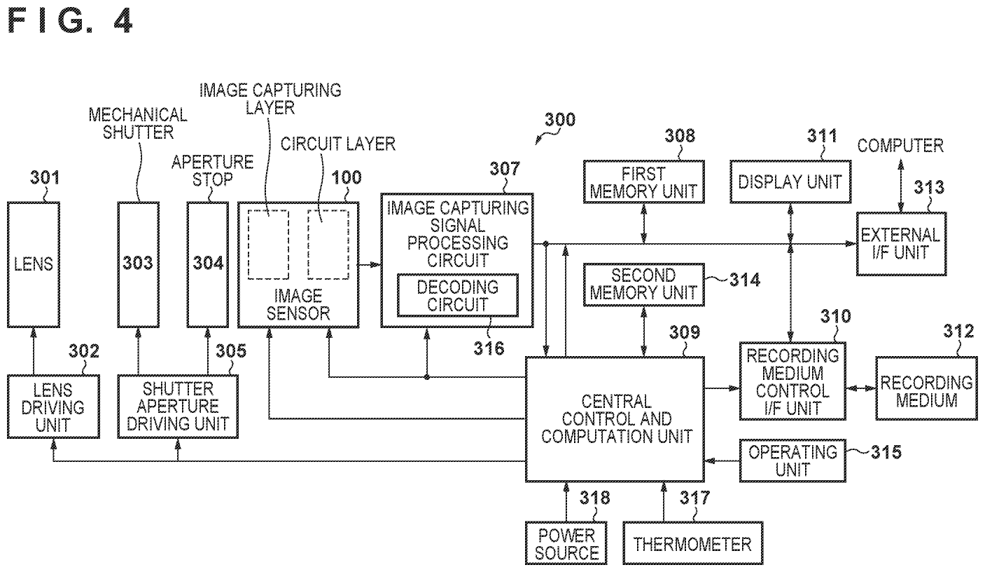

FIG. 4 is a block diagram illustrating the configuration of an image capturing apparatus 300 using the image sensor described in the present embodiment with reference to FIGS. 1 to 3.

As illustrated in FIG. 4, the image capturing apparatus 300 includes a lens 301, a lens driving unit 302, a mechanical shutter 303, an aperture stop 304, a shutter/aperture driving unit 305, the image sensor 100, and the image capturing signal processing circuit 307. The image capturing apparatus 300 also includes a first memory unit 308, the central control and computation unit 309, a recording medium control interface unit (also called a “recording medium control I/F unit” hereinafter) 310, a display unit 311, a recording medium 312, and an external interface unit (also called an “external I/F unit” hereinafter) 313. The image capturing apparatus 300 further includes a second memory unit 314, an operating unit 315, a decoding circuit 316, a thermometer 317, and a power source 318.

Reflected light from a subject, which has passed through the lens 301, is adjusted to a suitable light amount by the aperture stop 304, and then forms a subject image on an imaging surface of the image sensor 100. The subject image formed on the imaging surface of the image sensor 100 is photoelectrically converted by the pixels 101, and is then subjected to gain adjustment and A/D-converted from analog signals to digital signals, which are sent to the image capturing signal processing circuit 307 as R, Gr, Gb, and B signals.

The image signal compressed by the image sensor 100 is decoded by the decoding circuit 316 of the image capturing signal processing circuit 307. Furthermore, the image capturing signal processing circuit 307 carries out predetermined computational processing using the captured image signal, and the central control and computation unit 309 carries out exposure control, automatic focus adjustment control, and the like on the basis of the obtained computational results. A TTL (through-the-lens) AE (automatic exposure) process and an EF (automatic flash adjustment) process are implemented as a result.

The image capturing signal processing circuit 307 also performs predetermined computational processing using the captured image signal, performing a TTL AWB (auto white balance) process based on the obtained computational results. Various types of image capturing signal processing, such as low-pass filtering for reducing noise and shading processing, as well as various types of correction, image signal compression, and so on are carried out as well.

Driving of the lens 301, such as zoom and focus, is controlled by the lens driving unit 302. The mechanical shutter 303 and the aperture stop 304 are driven and controlled by the shutter/aperture driving unit 305. The central control and computation unit 309 carries out control of and various types of operations for the image capturing apparatus 300 as a whole.

The first memory unit 308 temporarily stores the image signal. The recording medium control interface unit 310 records or reads out the image signal into or from the recording medium. The display unit 311 displays the image signal. The recording medium 312 is a removable recording medium such as semiconductor memory, and the image signal is recorded into or read out from the recording medium 312.

The external interface unit 313 is an interface for communicating with an external computer or the like. The second memory unit 314 stores computational results from the central control and computation unit 309. Information regarding driving conditions of the image capturing apparatus 300 set by a user through the operating unit 315 is sent to the central control and computation unit 309, and the image capturing apparatus 300 is controlled as a whole on the basis of that information. The thermometer 317 is used to measure the temperature of the image capturing apparatus 300. The power source 318 is a primary battery such as an alkaline battery, a secondary battery such as a NiCd battery, a NiMH battery, or a Li-ion battery, an AC adapter, or the like.

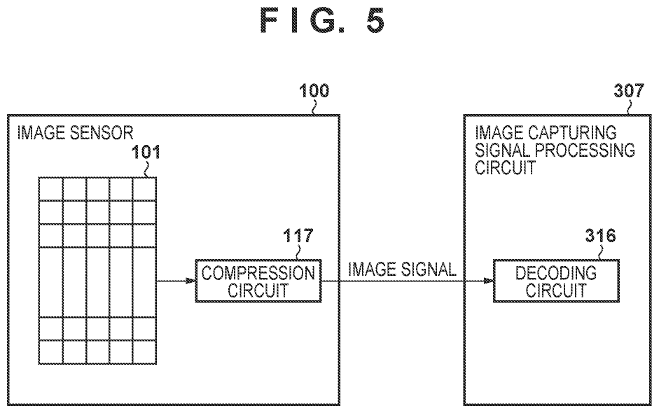

FIG. 5 is a diagram illustrating a connection between the image sensor 100 and the image capturing signal processing circuit 307 according to the present embodiment. When outputting the image signal, the image sensor 100 switches the transfer of the image signal to the image capturing signal processing circuit 307 depending on whether the compression is or is not carried out by the compression circuit 117. In the image capturing signal processing circuit 307, the decoding circuit 316 carries out a process for decoding the image signal.

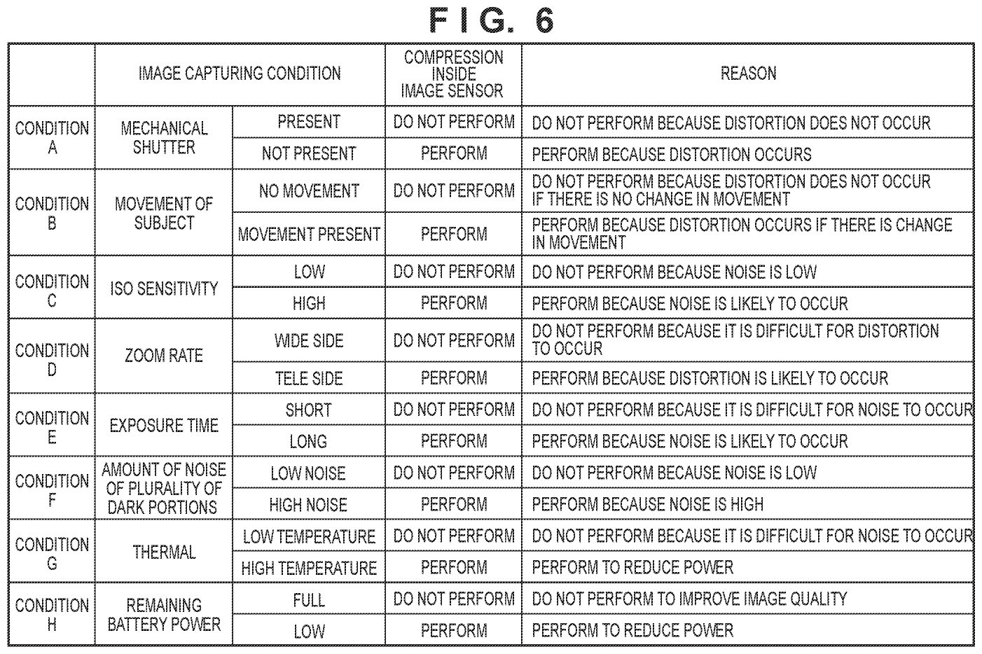

FIG. 6 is a diagram illustrating conditions for determining whether or not to carry out compression in the image sensor 100. The central control and computation unit 309 makes the determination according to each condition. With condition A in FIG. 6, whether or not to use the compression circuit 117 is determined according to whether or not shooting was carried out using the mechanical shutter 303 (mechanical shutter used/not used). Although rolling shutter distortion does not occur if the image signal is transferred after the mechanical shutter 303 is closed, a time difference arises between the upper and lower parts of the screen when transferring the signal while the mechanical shutter 303 is open, which results in distortion. Such a case requires high-speed transfer, and thus the compression circuit 117 is used.

With condition B in FIG. 6, whether or not to use the compression circuit 117 is determined in accordance with the movement speed of the subject. The movement speed of the subject is determined by the image capturing signal processing circuit 307 calculating a difference between the image signal from the previous frame and the image signal from the current frame. If the calculated movement amount of the subject is great, there will be increased rolling shutter distortion, and thus the image signal is compressed in the compression circuit 117. The compression circuit 117 is not used if the movement amount is low.

A user can set a shooting mode using the operating unit 315. An auto mode, a silent shooting mode that does not use the mechanical shutter 303, and the like are provided as shooting modes. The auto mode is a still image shooting mode in which various types of camera parameters are determined automatically, on the basis of measured evaluation values, by a program incorporated into the image capturing signal processing circuit 307.

The silent shooting mode does not use the mechanical shutter 303, and is therefore a mode in which operational noise of the mechanical shutter 303 can be eliminated. The silent shooting mode is therefore suited to shooting quiet scenes. Because the mechanical shutter 303 is not used during the silent shooting mode, rolling shutter distortion is more likely to occur. As such, before shooting a still image, the readout driving of the image sensor 100 is changed to the multi-stream driving 2 in order to make it easier to detect the movement amount of the subject, and high-speed readout is carried out using 1/7 vertical thinning with horizontal mixing driving.

With condition C in FIG. 6, whether or not to use the compression circuit 117 is determined in accordance with whether or not the ISO sensitivity is high. A higher ISO sensitivity produces more noise in the image sensor 100, and thus using the compression circuit 117 makes it possible to reduce the noise. This is because when compression is carried out, the bit precision drops, and the image quality will drop as a result, but unnecessary components such as noise are also removed, and noise is likely to be reduced as well.

With condition D in FIG. 6, whether or not to use the compression circuit 117 is determined in accordance with the zoom rate of the lens 301. A higher zoom rate means that shake in the user's hand will be more marked, which increases the likelihood of rolling shutter distortion, and thus the compression circuit 117 is used.

With condition E in FIG. 6, whether or not to use the compression circuit 117 is determined in accordance with the exposure time of the image sensor 100. A longer exposure time produces more noise in the image sensor 100, and thus the compression circuit 117 is used to reduce the noise.

With condition F in FIG. 6, whether or not to use the compression circuit 117 is determined in accordance with the amount of noise in the image signal from the image sensor 100. The average value of noise amounts in the image signals from a plurality of frames is measured, and if the calculated noise amount is greater than or equal to a set value, the noise is reduced by using the compression circuit 117.

With condition G in FIG. 6, the thermometer 317 measures the temperature of the image capturing apparatus 300, and whether or not to use the compression circuit 117 is determined in accordance with whether or not the temperature is high. If the temperature is high, the temperature can be reduced by reducing the power. As such, the power can be reduced by compressing the image signal in the compression circuit 117 and reducing the amount of data transferred.

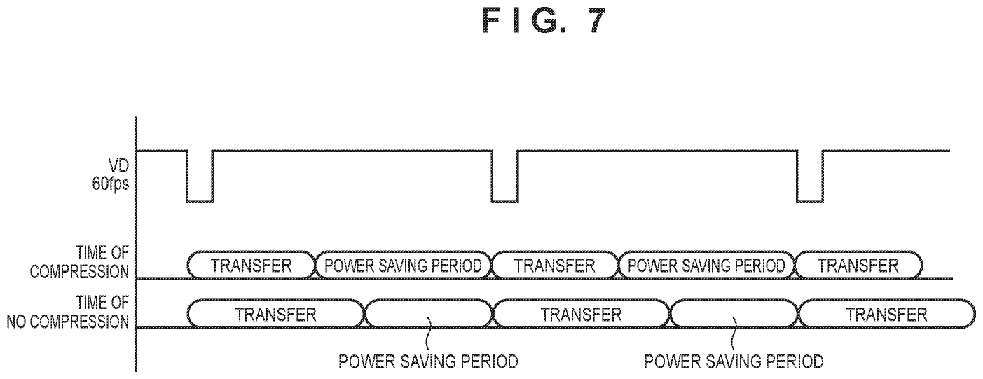

A power-saving effect achieved when reducing the amount of data transferred will be described here using FIG. 7. The image sensor 100 can carry out power saving operations, where the image sensor 100 is not operated, during a period from when the transfer of the image signal has ended to when the transfer starts for the next frame. Using the compression circuit 117 to reduce the amount of data transferred makes it possible to make the power saving period longer than when the compression circuit 117 is not used, which makes it possible to reduce the power.

With condition H in FIG. 6, whether or not to use the compression circuit 117 is determined in accordance with the remaining battery power of the power source 318 in the image capturing apparatus 300. If the remaining battery power is low, it is necessary to reduce the power, and thus the power is reduced by compressing the image signal in the compression circuit 117 and reducing the amount of data transferred.

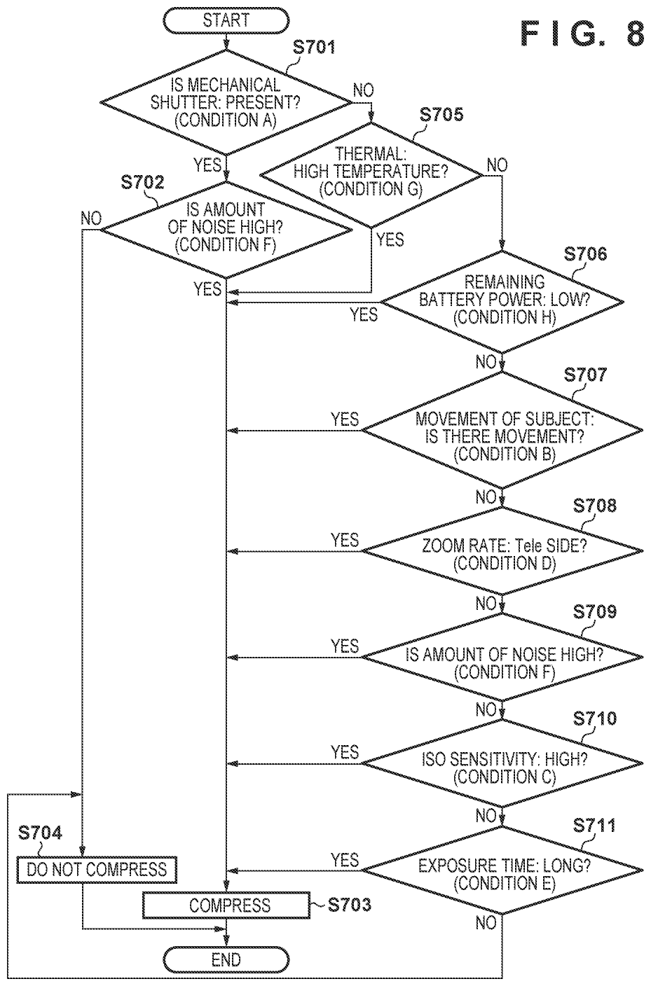

FIG. 8 is a flowchart illustrating a sequence for determining whether or not to carry out compression on the basis of the conditions illustrated in FIG. 6.

In step S701, the central control and computation unit 309 determines whether or not the mechanical shutter 303 is used (condition A). If the determination of step S701 indicates that the mechanical shutter 303 is used, the process moves to step S702, whereas if the mechanical shutter 303 is not used, the process moves to step S705.

In step S702, it is determined whether or not the noise amount is greater than a predetermined amount (condition F). If it is determined in step S702 that the noise amount is greater than the predetermined amount, the process moves to step S703, whereas if it is not determined that the noise amount is greater than the predetermined amount, the process moves to step S704. In step S703, the compression circuit 117 compresses the image signal, and the sequence for determining whether or not to carry out compression ends. In step S704, the sequence for determining whether or not to carry out compression ends without using the compression circuit 117.

In step S705, it is determined whether or not the temperature of the image capturing apparatus is higher than a predetermined temperature (condition G). If it is determined in step S705 that the temperature is higher than the predetermined temperature, the process moves to step S703, whereas if it is determined that the temperature is not higher than the predetermined temperature, the process moves to step S706.

In step S706, it is determined whether or not the remaining battery power is less than a predetermined amount (condition H). If it is determined in step S706 that the remaining battery power is less than the predetermined amount, the process moves to S703, whereas if it is determined that the remaining battery power is not less than the predetermined amount, the process moves to step S707.

In step S707, it is determined whether or not the subject is moving (condition B). If in step S707 it is determined that the subject is moving, the process moves to step S703, whereas if it is determined that the subject is not moving, the process moves to step S708.

In step S708, it is determined whether or not the zoom rate is further on the tele side than a predetermined rate (condition D). If in step S708 it is determined that the zoom rate is high on the tele side, the process moves to step S703, whereas if it is determined that the zoom rate is not high on the tele side, the process moves to step S709.

In step S709, it is determined whether or not the noise amount is greater than a predetermined amount (condition F). If it is determined in step S709 that the noise amount is greater than the predetermined amount, the process moves to step S703, whereas if it is not determined that the noise amount is greater than the predetermined amount, the process moves to step S710.

In step S710, it is determined whether or not the ISO sensitivity is higher than a predetermined sensitivity (condition C). If it is determined in step S710 that the ISO sensitivity is higher than the predetermined sensitivity, the process moves to step S703, whereas if it is not determined that the ISO sensitivity is higher than the predetermined sensitivity, the process moves to step S711.

In step S711, it is determined whether or not the exposure time is a long exposure time which is longer than a predetermined amount of time (condition E). If it is determined in step S711 that the exposure time is a long exposure time, the process moves to step S703, whereas if it is not determined that the exposure time is a long exposure time, the process moves to step S704.

As described thus far, the transfer time can be shortened while suppressing a drop in image quality by switching between whether or not to compress the image signal in the image sensor 100 in accordance with shooting conditions (image capturing conditions).

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™, a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2018-111243, filed Jun. 11, 2018, and 2019-079568, filed Apr. 18, 2019, which are hereby incorporated by reference herein in their entirety.

What is claimed is:

1. An image capturing apparatus comprising:
an image sensor including a plurality of pixels that photoelectrically convert a subject image, and a compression circuit that compresses signals from the plurality of pixels; and
at least one processor or circuit configured to function as the following units:
a readout unit that reads out the signals of the plurality of pixels from the image sensor; and
a control unit that, in accordance with an image capturing condition, controls a compression operation performed on the signals of the plurality of pixels by the compression circuit.

2. The image capturing apparatus according to claim 1,
wherein the image capturing condition includes whether or not a mechanical shutter is used; and
the control unit carries out control so that the signals of the plurality of pixels are compressed by the compression circuit in the case where image capturing has been carried out without using the mechanical shutter.

3. The image capturing apparatus according to claim 1,
wherein the image capturing condition includes a noise amount in the signals from the pixels; and
the control unit carries out control so that the signals of the plurality of pixels are compressed by the compression circuit in the case where the noise in the signals from the pixels is greater than a predetermined amount.

4. The image capturing apparatus according to claim 1,
wherein the image capturing condition includes a temperature of the image capturing apparatus; and
the control unit carries out control so that the signals of the plurality of pixels are compressed by the compression circuit in the case where the temperature of the image capturing apparatus is higher than a predetermined temperature.

5. The image capturing apparatus according to claim 1,
wherein the image capturing condition includes remaining battery power; and
the control unit carries out control so that the signals of the plurality of pixels are compressed by the compression circuit in the case where the remaining battery power is less than a predetermined amount.

6. The image capturing apparatus according to claim 1,
wherein the image capturing condition includes movement of a subject; and
the control unit carries out control so that the signals of the plurality of pixels are compressed by the compression circuit in the case where the subject is moving.

7. The image capturing apparatus according to claim 1,
wherein the image capturing condition includes a zoom rate; and
the control unit carries out control so that the signals of the plurality of pixels are compressed by the compression circuit in the case where the zoom rate is higher than a predetermined rate.

8. The image capturing apparatus according to claim 1,
wherein the image capturing condition includes noise in the signals from the pixels; and
the control unit carries out control so that the signals of the plurality of pixels are compressed by the compression circuit in the case where the noise in the signals from the pixels is greater than a predetermined amount.

9. The image capturing apparatus according to claim 1,
wherein the image capturing condition includes an ISO sensitivity; and
the control unit carries out control so that, in the case where the ISO sensitivity is higher than a predetermined sensitivity, the signals of the plurality of pixels are compressed by the compression circuit before being read out.

10. The image capturing apparatus according to claim 1,
wherein the image capturing condition includes an exposure time; and
the control unit carries out control so that the signals of the plurality of pixels are compressed by the compression circuit in the case where the exposure time is longer than a predetermined amount of time.

11. A method of controlling an image capturing apparatus, the apparatus including an image sensor having a plurality of pixels that photoelectrically convert a subject image and a compression circuit that compresses signals of the plurality of pixels, and the method comprising:
reading out the signals of the plurality of pixels from the image sensor; and
in accordance with an image capturing condition, controlling a compression operation performed on the signals of the plurality of pixels by the compression circuit.
